(19) United States
(12) Patent Application Publication
(10) Pub. No.: US 2026/0249736 A1
(43) Pub. Date: Aug. 27, 2026

(54) Systems and Methods for High Availability Battery Electric Vehicles AC/DC Charging Local Load Management

(71) Applicant: Ampure Charging Systems, Inc., Monrovia, CA (US)

(72) Inventors: Dennis Rolland, Costa Mesa, CA (US); Sathvik Reddy Gaddam, Anaheim, CA (US)

(21) Appl. No.: 19/060,200

(22) Filed: Feb. 21, 2025

(51) Int. Cl. B60L 53/68; B60L 53/63; B60L 53/67

(52) U.S. Cl. CPC B60L 53/68; B60L 53/63; B60L 53/67

(57) ABSTRACT

Systems, devices, and methods including communicating between charging stations via a local area network (LAN); electing, by the charging stations, a master charging station among the charging stations, where the rest of the charging stations that excludes the master charging station include slave charging stations; and allocating, by the master charging station, power from a grid supply across the charging stations on the LAN.

### FIELD OF ENDEAVOR

Embodiments relate generally to Battery Electric Vehicles (BEV) charging, and more particularly to BEV charging management.

### BACKGROUND

BEV charging involves providing electrical energy to recharge multiple vehicles'batteries efficiently. Charging stations are designed to manage the demand from several electric vehicles (EVs) simultaneously to optimize energy distribution, prevent overloads, and ensure reliable service. These systems may need remote monitoring and load balancing to support the seamless operation of multiple vehicles while minimizing downtime and maximizing energy efficiency.

Meanwhile, high availability is a concept for adding redundancy and fault tolerant solutions to computer, networking, and software solutions. High availability ensures continuous service by using redundant systems and failover mechanisms that automatically transfer workloads during failures. It aims to minimize downtime and is essential for mission-critical applications, ensuring reliability with near-constant uptime.

### SUMMARY

The embodiments of the present disclosure comprises: a method comprising: communicating between each of charging stations via a local area network (LAN); electing, by the charging stations, a master charging station among the charging stations, wherein the rest of the charging stations that excludes the master charging station include slave charging stations; and allocating, by the master charging station, power from a grid supply across the charging stations on the LAN.

In one embodiment, the master charging station may be configured to allocate the power in two modes including: an equal shared mode where an allocation for each of the charging stations is configured to be determined equally by dividing the power by the number of the charging stations; and a priority charging mode where an allocation for each of the charging stations is configured to be determined unevenly according to a price for priority charging.

In one embodiment, the method may further comprise detecting, by slave charging stations, the failure of the master charging station.

In one embodiment, the detecting the failure of the master charging station may be performed by detecting loss of connectivity to the master charging station, and wherein if the failure of the master charging station is detected, the slave charging stations may begin an election process to elect a new master charging station.

In one embodiment, while the master charging station in the failure state fails over to the new master charging station, active charging sessions via the charging stations may not be disrupted.

In one embodiment, when the new master charging station is elected and failed over, the master charging station in the failure state may be configured to become an old master charging station; wherein if charging for the old master charging station is still in progress, the old master charging station may continue charging with a power allocation previously determined for an active charging session; wherein the method may further comprise: reallocating, by the new master charging station, remaining power across the rest of the charging stations on the LAN; and wherein the remaining power may include the power from the grid supply that excludes the power allocation to the old master charging station, and the rest of the charging stations may include the charging stations that excludes the old master charging station.

In one embodiment, when the new master charging station is elected and failed over, the master charging station in the failure state may be configured to become an old master charging station; wherein if charging for the old master charging station is ended, the method may further comprise: reallocating, by the new master charging station, the power across the charging stations with optimal power allocations for new charging sessions.

In one embodiment, the method may further comprise a cloud backend configured to be connected to the master charging station to manage charging of the charging stations, wherein if the master charging station is disconnected from the cloud backend as an offline mode, the master charging station may be configured to assume the role of the cloud backend until the connection is restored.

In one embodiment, the method may further comprise: authenticating, by the charging stations, a vehicle to be charged based on database previously registered; and wherein any new charging sessions for the charging stations in the offline state may be allowed without a time limit.

In one embodiment, electing the master charging station among the charging stations may be performed by comparing IP address of the charging stations.

The embodiments of the present disclosure comprise: a cluster of charging stations configured to be supplied power from a grid supply and communicate with each other via a local area network (LAN), wherein the charging stations include: a master charging station configured to be elected among the charging stations, and slave charging stations including the rest of the charging stations; and a backend configured to be run on the master charging station and communicate with each of the charging stations via the LAN; and wherein the master charging station is configured to allocate the power across the charging stations on the LAN.

In one embodiment, the master charging station may be configured to allocate the power in two modes including: an equal shared mode where an allocation for each of the charging stations is configured to be determined equally by dividing the power by the number of the charging stations; and a priority charging mode where an allocation for each of the charging stations is configured to be determined unevenly according to a price for priority charging.

In one embodiment, the charging stations in the cluster may be configured to detect the failure of the master charging station.

In one embodiment, detecting the failure of the master charging station may be performed by detecting loss of connectivity to the master charging station, and wherein if the failure of the master charging station is detected, the slave charging stations may begin an election process to elect a new master charging station

In one embodiment, while the master charging station in the failure state fails over to the new master charging station, active charging sessions via the charging stations may not be disrupted.

In one embodiment, when the new master charging station is elected, the master charging station in the failure state may be configured to become an old master charging station; wherein if charging for the old master charging station is still in progress, the old master charging station may continue charging with an allocation previously determined for an active charging session; wherein the new master charging station may be configured to reallocate remaining power across the rest of the charging stations on the LAN; and wherein the remaining power may include the power from the grid supply that excludes the allocation to the old master charging station, and the rest of the charging stations may include the charging stations that excludes the old master charging station.

In one embodiment, when the new master charging station is elected, the master charging station in the failure state may be configured to become an old master charging station, wherein if charging for the old master charging station is ended, the new master charging station may be configured to reallocate the power across the charging stations on the LAN, and new charging sessions for the charging stations may occur at optimal power allocations.

In one embodiment, the system may further comprise a cloud backend configured to be connected to the master charging station to manage charging of the charging stations, wherein if the master charging station is disconnected from the cloud backend as an offline mode, the backend run on the master charging station may be configured to assume the role of the cloud backend until the connection is restored.

In one embodiment, the charging stations may be configured to authenticate a vehicle to be charged based on database previously registered; and wherein any new charging sessions for the charging stations in the offline state may be allowed without a time limit.

The embodiments of the present disclosure comprise electing, by charging stations, a master charging station among the charging stations, wherein the rest of the charging stations that excludes the master charging station include slave charging stations; allocating, by the master charging station, power from a grid supply across the charging stations; detecting, by the slave charging stations, the failure of the master charging station; and reelecting, by the slave charging stations, a new master charging station among the slave charging stations if the failure of the master charging station is detected.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a diagram of master and slave electric vehicle supply equipment (EVSE) charging station topology, according to one embodiment;

FIGS. 2A to 2H depict diagrams for master election states, according to one embodiment;

FIG. 3 depicts a flowchart for master election process, according to one embodiment;

FIG. 4 depicts a flowchart for master failsafe process, according to one embodiment;

FIGS. 5A and 5B depict diagrams of local controller websocket connection for the present system and method, according to one embodiment;

FIG. 6 depicts a sequence diagram of a local charging process using the present system and method, according to one embodiment;

FIG. 7 depicts a flow chart for a budget allocation process using the present system and method, according to one embodiment;

FIG. 8 depicts a flow chart for an equal shared mode of a budget allocation process, according to one embodiment;

FIG. 9 depicts a flow chart for a priority charging mode of a budget allocation process, according to one embodiment;

FIG. 10 depicts a flow chart for a method of local load management, according to one embodiment;

FIG. 11 illustrates an example top-level functional block diagram of a computing device embodiment;

FIG. 12 shows a high-level block diagram and process of a computing system for implementing an embodiment of the system and process;

FIG. 13 shows a block diagram and process of an exemplary system in which an embodiment may be implemented; and

FIG. 14 depicts a cloud computing environment for implementing an embodiment of the system and process disclosed herein.

### DETAILED DESCRIPTION

The following description is made for the purpose of illustrating the general principles of the embodiments discloses herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

The present disclosure provides systems and methods for the high availability AC/DC charging solution for electric vehicles (EV), such as battery electric vehicles (BEV), plugin hybrid electric vehicles (PHEV), and battery-powered industrial and ground support equipment. The present systems and methods provide a highly available, fault tolerant solution to a cluster of charging stations connected via wired or wireless local area network (LAN) in a master and slave topology. The solution may comprise a network connected group of charging stations where one of the charging stations is configured as a master charging station and the others are slave charging stations. The slave charging stations have the capability of assuming the role of the master charging station in the event of a master charging station failure. The master charging station acts as a local controller responsible for distributing the electrical load equally or unevenly across all slave charging stations on the network without exceeding the electrical grid supply power budget.

Accordingly, the present systems and methods for the high availability AC/DC charging solution may provide the following technical features. First, the present systems and methods provides a fault tolerance solution which continues to operate in the event a master charging station (local controller) fails. In the event of a failure, the responsibility of the local controller is automatically failed over to a newly elected local controller. During this failing over process, the slave charging stations may detect whether the master charging station has failed. If the slave charging stations find the master charging station has failed by detecting a failure or loss of connectivity to the master charging station, the slave charging stations may begin the election process to elect a new master charging station.

Secondly, there is no disruption to active charging sessions in the event of a loss of connectivity to the cloud backend, which may be included in a Charge Station Management System (CSMS). If connectivity is lost, then the present local load management (LLM) system continues to operate in an offline mode and the master charging station (local controller) operates as a CSMS.

Third, there is also no disruption to active charging sessions in the event of the current master charging station (current local controller) failure. If the current master charging station (current local controller) fails, then the active charging sessions continue, while the failover process takes place. Last but not least, there is no other conventional solution on the market which provides fault tolerance to battery electric equipment charging devices.

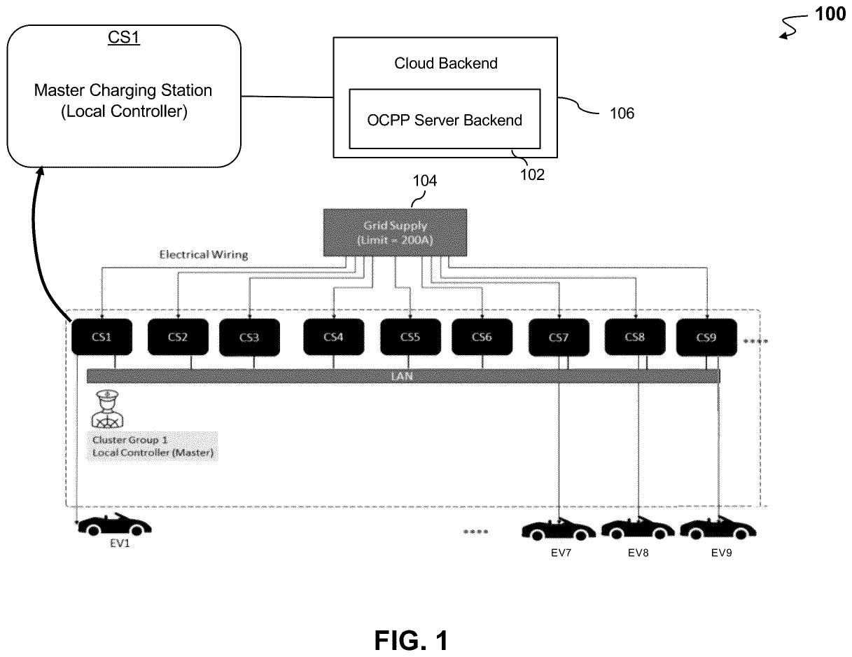

FIG. 1 depicts a diagram of master and slave electric vehicle supply equipment (EVSE) charging station topology, according to one embodiment. Referring to FIG. 1, the present local load management (LLM) system 100 may include: a cluster of charging stations CS1 to CS9 each configured to charge each vehicle EV1 to EV9; a backend 102 (e.g., Open Charge Point Protocol (OCPP) server backend) configured to communicate with each of the charging stations CS1 to CS9 via a local area network (LAN); and a grid supply 104 configured to provide power to the charging stations CS1 to CS9. One CS1 of the charging stations CS1 to CS9 may be elected as a master charging station, and the other charging stations CS2 to CS9 may be determined as slave charging stations. The master charging station CS1 may act as a local controller responsible for distributing the electrical load equally or unevenly across the master charging station CS1 and all slave charging stations CS2 to CS9 on the network without exceeding the electrical power budget of the grid supply 104. In the embodiment shown in FIG. 1, the first charging station CS1 may be a master charging station, and the second to ninth charging station CS2 to CS9 may be slave charging stations.

The LLM system 100 may include two backends 102, 106, which may operate as a Charge Station Management System (CSMS) or central system. One of them may be an OCPP server backend 102. The OCPP server backend 102 may run on the master charging station CS1 where all the slave charging stations CS2 to CS9 connects to, and the master charging station CS1 with the OCPP server backend 102 may act as a local controller. The OCPP server backend 102 may be configured to run on the master charging station CS1 using an OCPP Backend URL, and all the slave charging stations CS2 to CS9 may connect to the OCPP server backend 102 that runs on the master charging station CS1 post master election. The other backend may be a cloud backend 106 which is mainly used for billing and management. Only the master charging station CS1 may connect to the cloud backend 106.

The load management or load balancing by the master charging station CS1 of the LLM system 100 may operate with or without connectivity between the master charging station CS1 and the cloud backend 106 in an online or offline mode. In the online mode, the master charging station CS1 may maintain connectivity to the cloud backend 106, and in this case, the cloud backend 106 operates as a CSMS or central system. In order to charge, each charging station CS1 to CS9 may be configured to connect to the OCPP server backend 102 that runs on the master charging station 102, and the master charging station 102 may connect to the cloud backend (CSMS or central system). In this online scenario, the master charging station CS1 may sniff and relay the OCPP messages from each charging station CS1 to CS9 to the cloud backend 106 and only intervene for messages that impact energy allocation and de-allocation that are needed for load management. Specifically, when the cloud backend is online, the master charging station may simply act as a proxy to relay all the OCPP messages to the cloud backend. In case the cloud backend is offline, the master charging station may act as a CSMS and access to the rest of the charging station for local load management. In this case, the whole cluster may operate in offline to the cloud backend.

On the other hand, the LLM system 100 may work in an offline mode without being connected to the cloud backend 106, which has operated as a CSMS. When the master charging station CS1 is no longer connected to the network, it means that the charging stations are in an offline mode. If connectivity between the cloud backend (CSMS) 106 and the master charging station CS1 in the LLM system 100 is lost, then the master charging station CS1 in the LLM system 100 may assume the role of the CSMS and continue to operate load management in an offline mode. In other words, if the master charging station CS1 disconnects from the cloud backend 106, then it assumes the role of the cloud backend 106 until the connection is restored. In this offline mode, the OCPP server backend 102 that runs on the master charging station CS1 may act as a CSMS or central system. The master charging station CS1 may not relay the OCPP messages from each charging station CS1 to CS9 to the cloud backend 106 and not respond all OCPP messages without involving the cloud backend 106.

As a master charging station, the first charging station CS1 may be configured to perform load management or load balancing. Specifically, as a master charging station, the first charging station CS1 may be configured to allocate and distribute electrical load equally across the slave charging stations on the LAN. For example, the grid supply 104 may supply 200 amps power supply, and each of electric vehicle EV1 to EV9 may take 40 amps. Depending on the number of vehicles charging at each charging station CS1 to CS9, the first charging station CS1 may perform load management as a master charging station. In other embodiments, the first charging station CS1, as a master charging station, may be configured to distribute electrical load unevenly across the slave charging stations on the LAN when there is a priority charging request by a premium price.

The high availability of charging may be obtained by detecting a failure or loss of connectivity to the master charging station (local controller) and then failing over to another charging station among slave charging stations CS2 to CS9 connected to the network. All the charging stations CS1 to CS9 including the master charging station CS1 and the slave charging stations CS2 to CS9 may be connected to each other via a local area network (LAN). While the failover process occurs, there is no disruption to active charging sessions in the charging stations CS1 to CS9. Once the new master charging station is elected, then new charging sessions may occur at optimal power levels.

Specifically, while the master charging station CS1 performs the load management, the charging station CS2 to CS9 may detect if there is a failure in the master charging station CS1. If the master charging station CS1 may go offline, damaged, or not working, this failure of master charging station CS1 may be detected by the rest of the charging station CS2 to CS9 in the cluster, and a new master charging station may be selected. Accordingly, charging may resume with load balancing by the new master charging station.

In some embodiments, the rest of the charging station CS2 to CS9 in the cluster may be configured to detect the failure of the master charging station CS1 by IP communication. The IP communication may be a device discovery using multicast domain name system (mDNS). As mentioned above, the master charging station CS1 may be configured to run the OCPP server backend 102. Every charging station CS1 to CS9 in the network (e.g., LAN) may be connected to the master charging station CS1 using OCPP WebSocket protocol. If a master charging station CS1 goes offline, every charging stations CS1 to CS9 also get disconnected from the OCPP server backend 106 using mDNS, and accordingly, these charging stations CS2 to CS9 find out that the master charging station CS1 is offline. That is two levels of confirmation. The offline and online status of the master charging station CS1 may be updated based on the OCPP connection or last seen heartbeat message. Specifically, the slave charging station may detect if the OCPP connection to the master charging station is disconnected. The master charging station routes OCPP commands to/from the slave charging stations, and if these commands time out, then the OCPP connection will be lost. In addition, the slave charging station may detect if there is no response from the master charging station to a heartbeat message. The heart beat message is inherent in the mDNS protocol.

Then, these charging stations CS2 to CS9 start to re-elect a new master charging station.

The role of backend (CSMS) is to allow Charge Point Operators (CPO) to remotely manage the charging stations CS1 to CS9. This may include authenticating users of the vehicles EV1 to EV9, remote diagnostics, software updates, reserving charging stations CS1 to CS9 for specific users, and others. If connectivity between the cloud backend (CSMS) 106 and the LLM system 100 is lost, the master charging station CS1 in the LLM system 100 may assume the role of the CSMS. Accordingly, the current charging session of the charging stations CS1 to CS9 may continue without interruption. In addition, new charging sessions may be possible in the certain situations. In some embodiments, new charging sessions may start when an EV can be authenticated via a Local Authentication list maintained in the master charging station CS1. In other embodiments, new charging sessions may start when free charging mode is enabled.

Specifically, in some embodiments, the system 100 may be configured to operate completely offline for a limited time. Since a charging session could be hours but any interruptions and connectivity may be intermittent or less than a charging session, the offline mode operation of the present system may allow the stable, continuous load management and charging. However, after the offline mode in a certain period, the system may need to operate online. The period for the offline mode may depend on the data (e.g., OCPP messages) accumulated. Once the accumulated data reaches the limit, the offline mode may be no longer accepted. Accordingly, charging may not be performed at that point. For example, the system may need to end charging after the predetermined charging session, which was determined during an online state, unless the system goes online to receive messages for another charging session. In another example, if another vehicle pulls up, it may not be able to authenticate itself to the system if the system is still offline. In other words, the system may have two modes. In a first mode for authentication, the system needs to be online to set up to allow the vehicle to authenticate themselves, for billing purposes through a mobile app or the like. Then, in a second mode, the system may go offline until the end of that transaction. The system may not be able to start a new transaction for that vehicle after the end of that transaction in an offline state.

In another embodiments, the system 100 may be configured to operate completely offline without a time limit. It may be when the EV to be charged is already identified and known to the system and thus the system does not need updated messages from the CSMS to determine whether charging should be maintained at a certain time point. For example, it may be a business's parking lot that business has a set up for their employees to charge, which may be provided for free. The system may have a mode using RFID cards to authenticate employees, and in this case, the system may run completely offline forever. Employees may authenticate themselves with RFID cards, or the charging stations may authenticate them by having a white list of those or local authentication list of the RFID cards. When there are new employees, new RFID cards may be issued and then added to the authentication list that runs in the system. Once the new RFID card information is put online, the EV using the new RFID can be charged via the system without a time limit. In some embodiments, these processes may be performed through a web interface.

In some embodiment, when the cloud backend 106 is disconnected from the master charging station CS1, the master charging station CS1 is configured to act as CSMS even when the rest of the charging stations in the cluster do not know that the cloud backend 106 is offline because the master charging station is acting as the CSMS. When the master charging station CS1 goes offline, a new master charging station may be elected among the remaining charging stations CS2 to CS9.

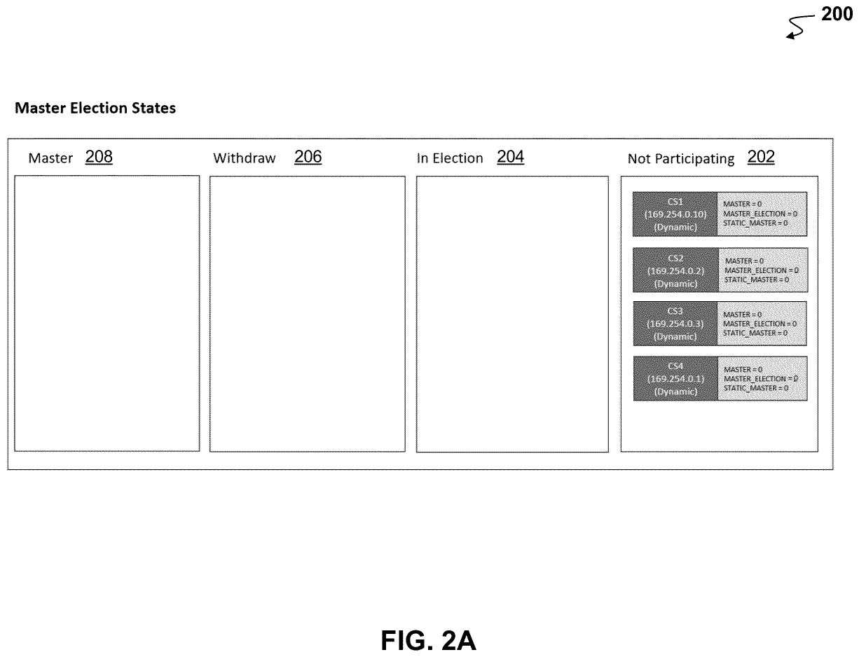

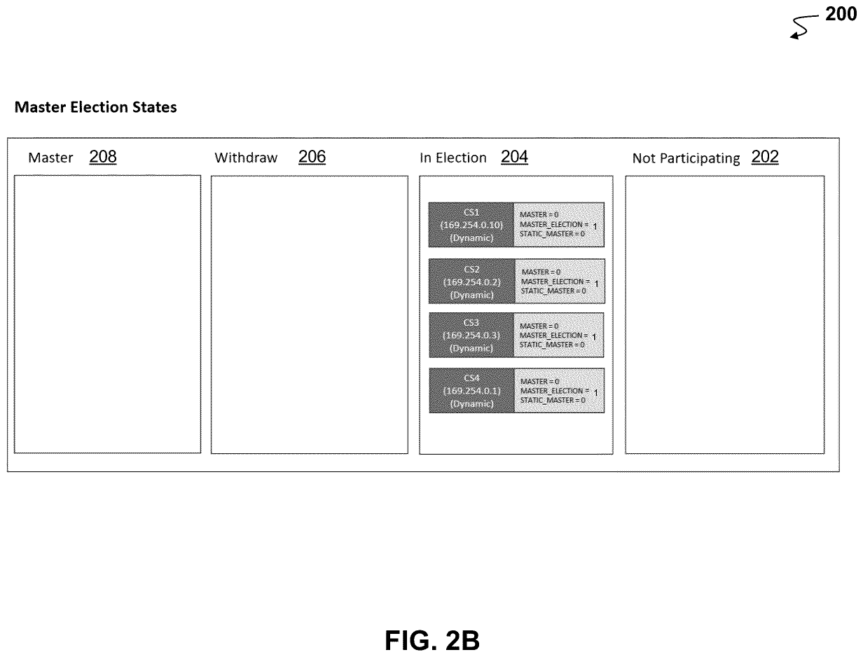

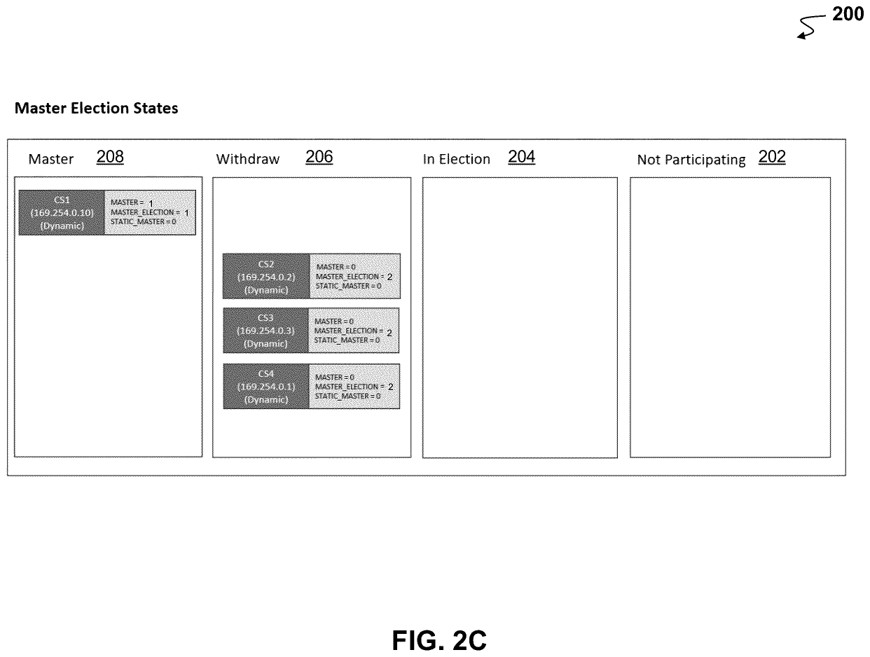

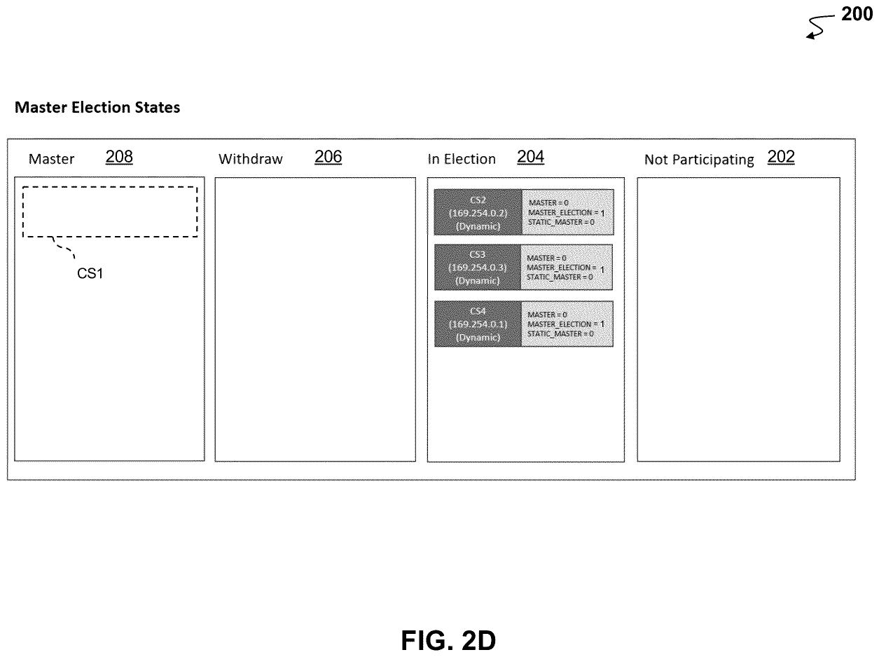

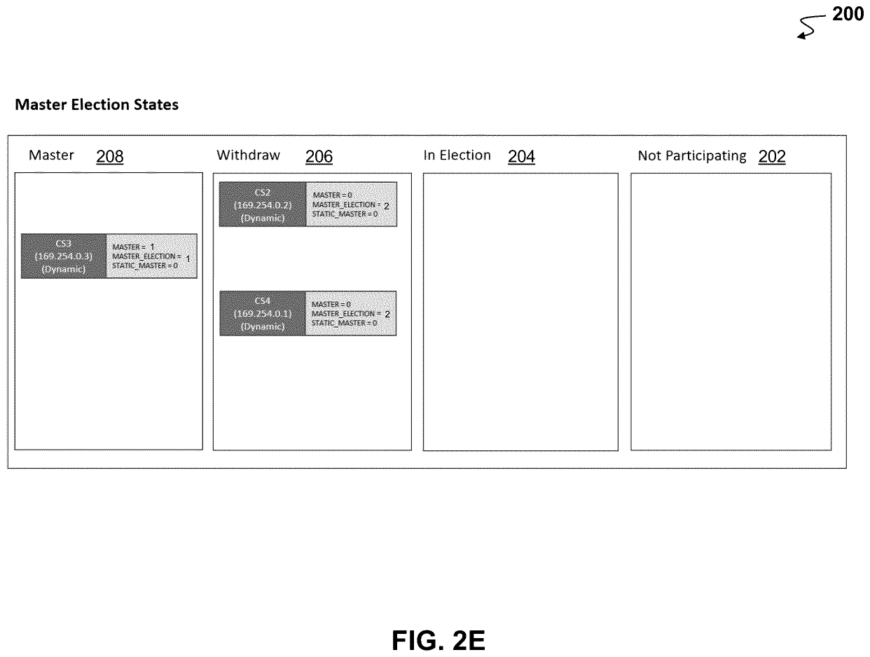

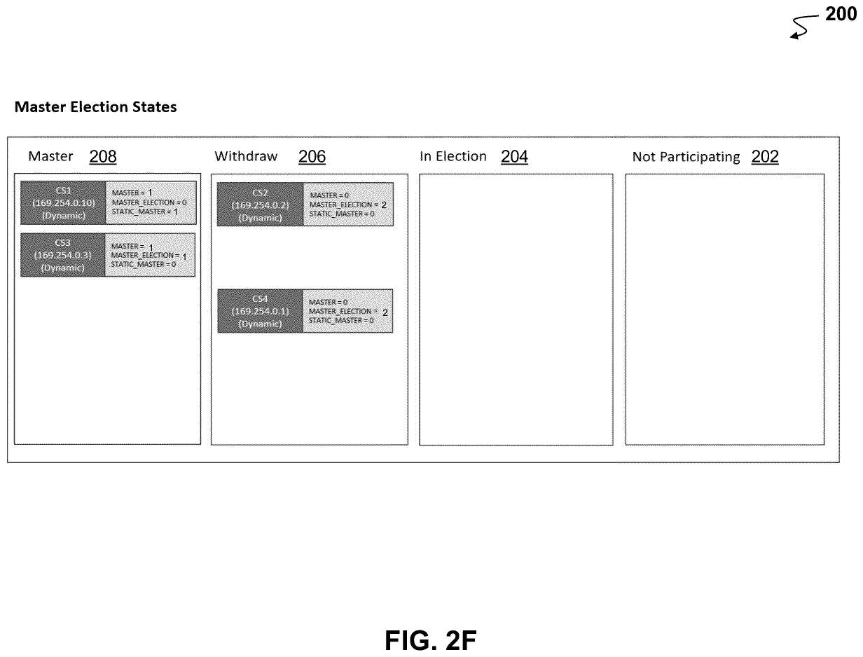

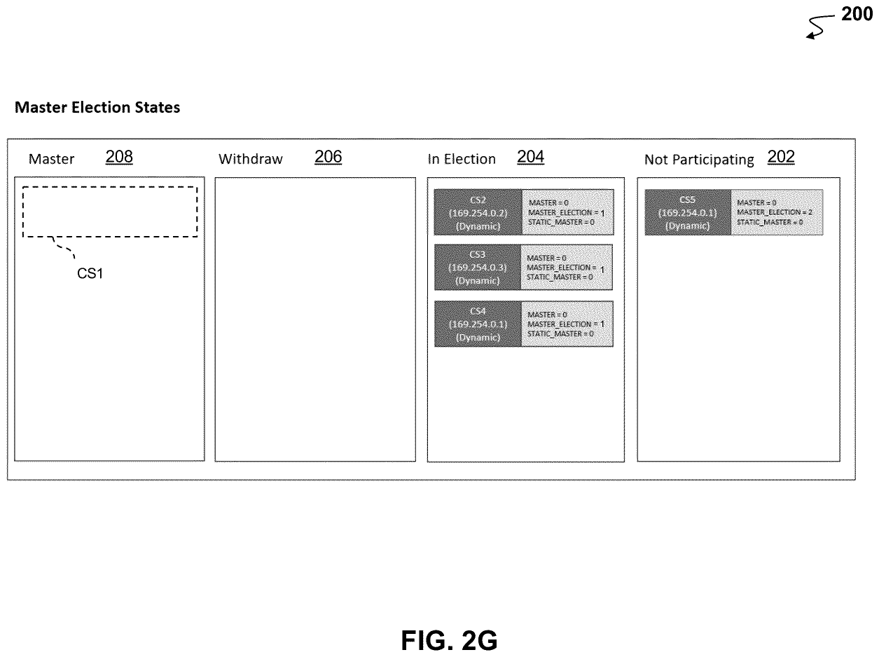

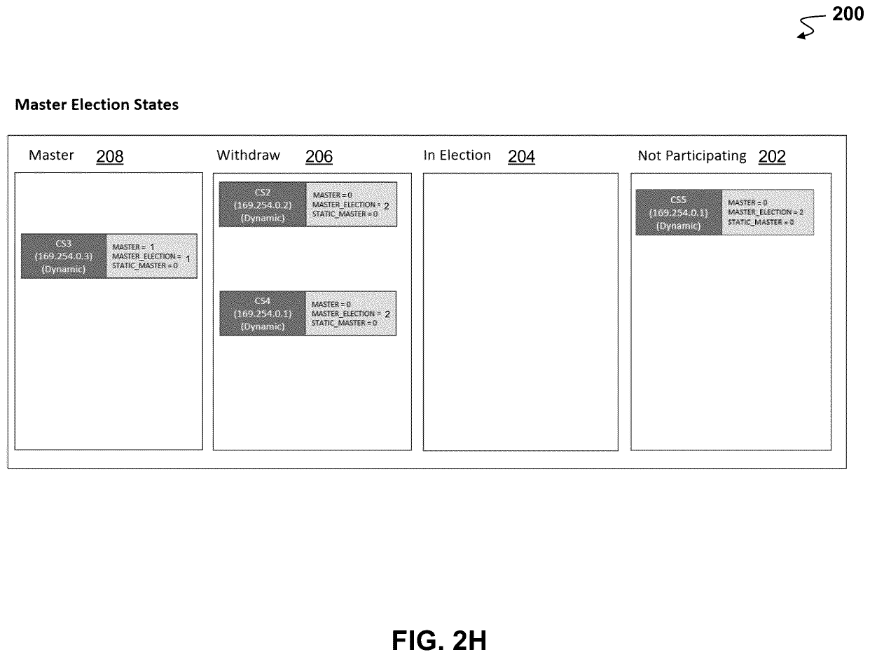

FIGS. 2A to 2H depict diagrams for master election states 200, according to one embodiment. Referring to FIGS. 2A to 2F, the election for master charging station may comprise four stages: Not Participating 202, In Election 204, Withdraw 206, and Master 208. As shown in FIG. 2A, when charging stations first join the network, they may be in non-participating state 202. Then, they may be in the election state 204 to participate in the election of a master charging station. As a next stage shown in FIG. 2B, one of them may be elected as a master charging station based on the IP address of each charging station. In some embodiments, the charging station with highest IP among the cluster of charging stations in election may be elected as a master charging station. In other embodiments, the charging station with lowest IP among the cluster of charging stations in election may be elected as a master charging station. In other embodiments, the master charging station may be elected among charging stations according to any rule or calculation based on the IP address of each charging station. As shown in FIG. 2C, the first charging station CS1, which has a highest IP (169, 254, 0, 10) among the cluster of charging stations including the first charging station CS1, the second charging station CS2 with an IP (169, 254, 0, 2), the third charging station CS3 with an IP (169, 254, 0, 3), and the fourth charging station CS4 with an IP (169, 254, 0, 1), may be elected as a master charging station in the master state 208. When the master charging station CS1 is elected, the rest of charging stations CS2, CS3, CS4 become in the withdraw state 206. The election result that the first charging station CS1 becomes a master charging station may be published to all of the charging stations.

In other embodiments, as shown in FIG. 2D, if the current master charging station, the first charging station CS1, goes offline, the rest of charging stations, the second to fourth charging stations CS2, CS3, CS4, go to the election state 204 again for reelection of a new master charging station. Then, as shown in FIG. 2E, one of them may be elected as a new master charging station based on the IP address. As described above, the charging station with next highest IP among the cluster of the charging stations in election may be elected as a new master charging station. In the embodiment shown in FIG. 2E, the third charging station CS3, which has a next highest IP (169, 254, 0, 3) among the cluster of charging stations CS1 to CS4 may be elected as a new master charging station in the master state 208. When the master charging station CS3 is elected, the rest of charging stations CS2, CS4 become in the withdraw state 206. The election result that the third charging station CS3 becomes a new master charging station may be published to all of the charging stations. In some embodiments, when the old master charging station CS1 comes back online, it may be in a static master charging station in the master state 208 as shown in FIG. 2F. Then, this static master charging station, the first charging station CS1, may become a master charging station that performs load management. In this case, the third charging station CS3 may go back in the withdraw state 206.

The whole algorithm above is to find out who will be a master charging station that performs the load balancing. Thus, even when the current master charging station, the first charging station CS1, goes offline, the charging stations CS1 to CS4 can still charge to EVs since another new master charging station keeps performing the load balancing.

Although the current state and/or operation of charging station is not provided to the system, the system may allow a new master charging station to manage power load that was associated with that charging stations within power budget so that the system does not supply other charging station more energy which may exceed the budget of a grid supply. If a current master charging station goes offline, then another charging station becomes a new master charging station. The new master charging station knows the previous power budgets. Specifically, in the above example, a current master charging station, the first charging station CS1, may go offline and the third charging station CS3 may become a new master charging station. In this case, charging stations within the cluster all know the previous power budget and allocations for each charging station. All the charging stations within the cluster always do data sync. Accordingly, when the new master charging station comes in, all the rest of the charging stations connect to the new master charging station, and they continue charging since the new master charging station knows the previous power budgets.

For example, as shown in FIGS. 2A and 2B, among 10 charging stations, four of them CS1 to CS4 may be taken for charging vehicles, and one of the four charging station, a first charging station CS1 for example, may be is a master charging station as shown in FIG. 2C. In this case, incoming power supply (e.g., 100 amps power supply) from a grid supply may be divided by four charging stations CS1 to CS4 equally (e.g., 25 amps each) and each of them is going to each charging station at maximum. Even when the master charging station CS1 goes offline as shown in FIG. 2D, the charging will still continue.

However, as shown in FIG. 2G, when a new vehicle comes in and is connected to another charging station CS5, there is no power budget since all the incoming power supply (e.g., 100 amps power supply) is provided to the four charging stations CS1 to CS4. Accordingly, the fifth charging station CS5 connected to the new vehicle may not charge until the budget is freed from the previous allocations.

As shown in FIG. 2H, while the master charging station CS1 goes offline, a new master charging station, a third charging station CS3, may be elected and take over. Since every charging station in the cluster already knows how much is allocated for each charging station, the new master charging station assumes that 25 amps is allocated to each charging station and the old master charging station CS1 is still taking the maximum of 25 amps. Thus, even though the third charging station C3 becomes a new master third charging station, the old master charging station CS1 will still continue charging with 25 amps in an offline state. Now the budget is only 75 amps. Accordingly, the old master charging station CS1 still takes 25 amps, and then 75 amps remains available and is divided by 4 charging stations CS2 to CS5. That is a failsafe feature.

Meanwhile, until the old master charging station CS1 comes back online, the new transaction for the old master charging station CS1 is stopped to end the charging session. It may need human interaction to bring the old master charging station CS1 back online.

When the old master charging station CS1 comes back online, a protocol in the OCPP server determines if the charging is ended or is it still in use. If the charging is still in progress, it remains at 25 amps until the charging is complete. If the charging is ended, the incoming power supply 100 amps is reallocated and divided by 5 charging stations CS1 to CS5, and each charging station takes 20 amps. In this way, the system provides failsafe dynamic load balancing. All charging stations may communicate using the OCPP protocol for a start transaction and stop transaction.

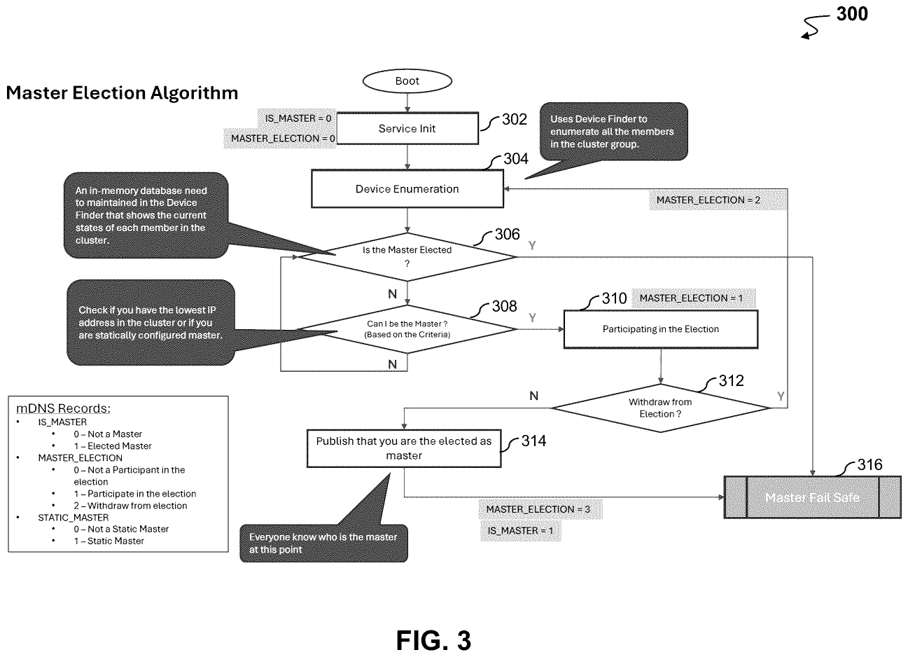

FIG. 3 depicts a flowchart for master election process 300, according to one embodiment. Referring to FIG. 3, on boot, the present systems and methods may initialize multicast DNS (mDNS) service (step 302). As shown in FIGS. 2A to 3, each charging station may have master flag (IS_MASTER), master election flag (MASTER_ELECTION), and static master flag (STATIC_MASTER). For the master flag, the state 0 indicates not a master, and the state 1 indicates an elected master. For the master election flag, the state 0 indicates not a participant in the election, the state 1 indicates a participant in the election, and the state 2 indicates withdraw from the election. For the static master flag, the state 0 indicates not a static master, and the state 1 indicates a static master. In some embodiments, the old master charging station may be configured as a static master when an operator or installer want to know exactly which charging station is going to be the master charging station. The reason for the static master charging station is to enable the CPO operator or installer to configure a specific charging station to be the master charging station. In the event of the static master failing, a new master charging station may be elected dynamically. If the old static master charging station were to come back online, then it may assume the role of a slave charging station since a master charging station already exists in the cluster.

To elect a master charging station, charging stations initialize a stage of not participating, with the state 0 both for the master flag and master election. The system may scan on the network to find who is on the network using mDNS. Once the system scan, it may learn the records of all the charging stations in the network. Every charging station may be in sync. If one of the records is changed, every charging stations may get notified. It is a part of the mDNS protocol. Once the system performs the enumeration (step 304), it may check if the master charging station is already elected (step 306). If so, charging stations do not participate in the election stage. They may wait for the current master charging station to fail. If a master charging station is not elected, charging stations may check if they could be the master charging station and may participate in the election stage (step 308). The charging stations may participate in the election stage by changing the state 1 for the master election flag (step 310). Then, based on the election, each charging station may check if it needs to withdraw and who is the new master to connect (step 312). For example, as described above, the charging station with highest IP among the cluster of charging stations in election may be elected as a master charging station, and the rest of charging stations may withdraw. If a charging station does not have to withdraw, then it becomes a master charging station and then publish that it is a master charging station (step 314). Then, the system may provide failsafe dynamic load balancing by a master charging station (step 316).

In this case, IP is not assigned by any Dynamic Host Configuration Protocol (DHCP) server as in traditional networks. Each IP may be a part of mDNS protocol, which is called Auto IP. Without using any external DHCP server, every charging station in the network may receive their own unique IP address. The system may use auto IP for address assignment, mDNS for name and device discovery.

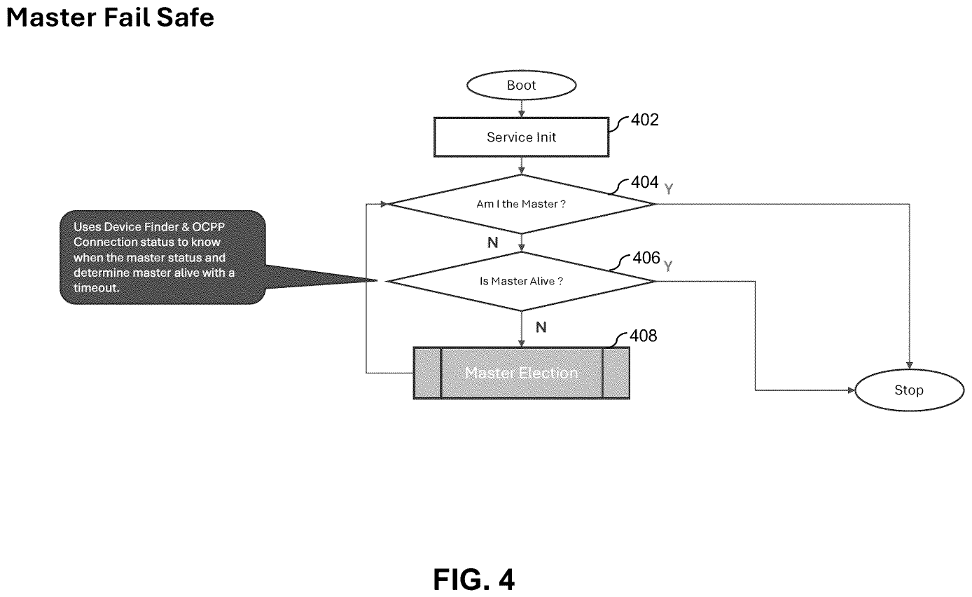

FIG. 4 depicts a flowchart for master failsafe process 400, according to one embodiment. Referring to FIG. 4, on boot, the present systems and methods may initialize multicast DNS (mDNS) service (step 402). Charging stations may check if they are the master charging station (step 404). If they are not a master charging station, they determine if the master charging station is alive (step 406). If the master charging station is not alive, the election for the master charging station may be performed as shown in FIG. 3 (step 408).

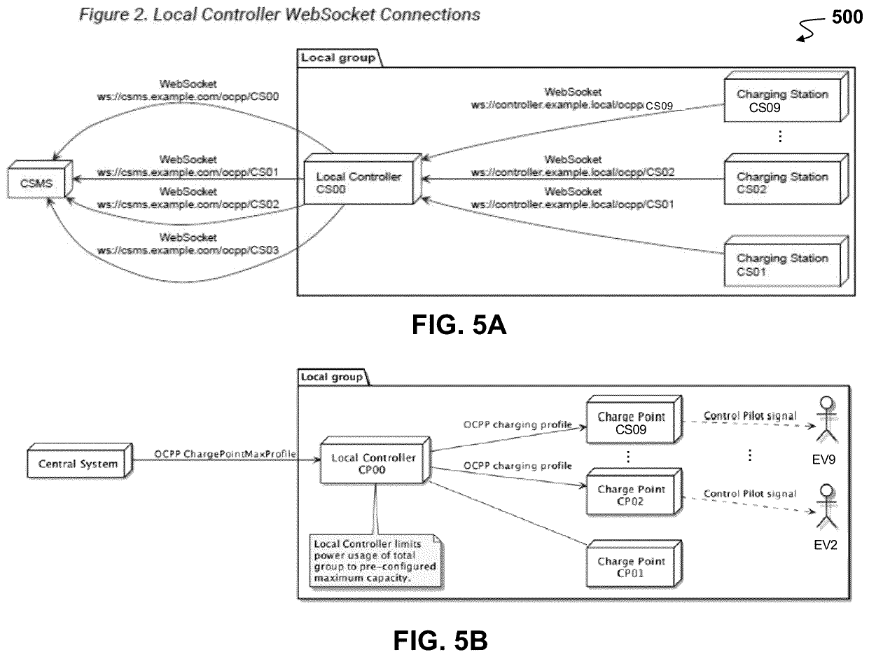

FIGS. 5A and 5B depict diagrams of local controller websocket connection 500 for the present system and method, according to one embodiment. Referring to FIGS. 5A and 5B, a master charging station CS00, which act as a local controller, may connect to the cloud backend, which operates as a CSMS, using a websocket protocol. The local controller CS00 (master charging station) may run an OCPP server backend and perform local load management. Every slave charging station CS01 to CS09 may connect to the local controller CS00 using a websocket protocol, and then the local controller CS00 may act as a proxy to the cloud backend of the CSMS. This may be OCPP standard. The local controller CS00 may be configured as a component that can run on a standalone hardware or part of the master charging station.

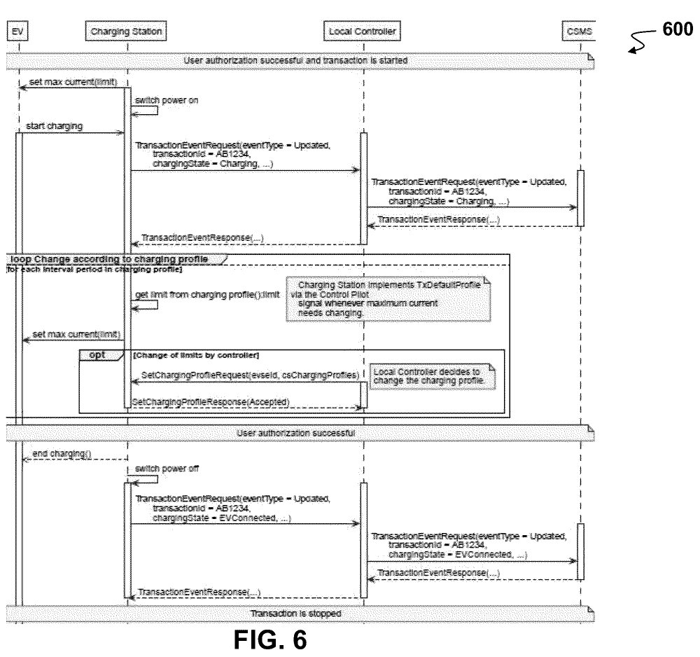

FIG. 6 depicts a sequence diagram of a local charging process 600 using the present system and method, according to one embodiment. Referring to FIGS. 5A to 6, the local charging process 600 may be performed by communication between an EV, a charging station, a local controller (master charging station), and a CSMS. To start a transaction, there may be a websocket connection between the charging station and the OCPP server backend on the local controller (master charging station) and between the local controller and the CSMS. The charging station may not decide where to route a start transaction request. The slave charging station may connect to only the local controller.

Specifically, when the EV needs to start charging, a transaction start request may be sent from the charging station, and then it needs to be authorized by the local controller because the local controller is acting as the backend. In some embodiments, the transaction start request may be authorized by the cloud backend. Then, once the transaction is approved, a limit is set to the charging station. It is the charging station responsibility to make sure that the EV does not exceed the limit. If the EV tries to consume more than the limit, it may need to open up the relays to the local controller.

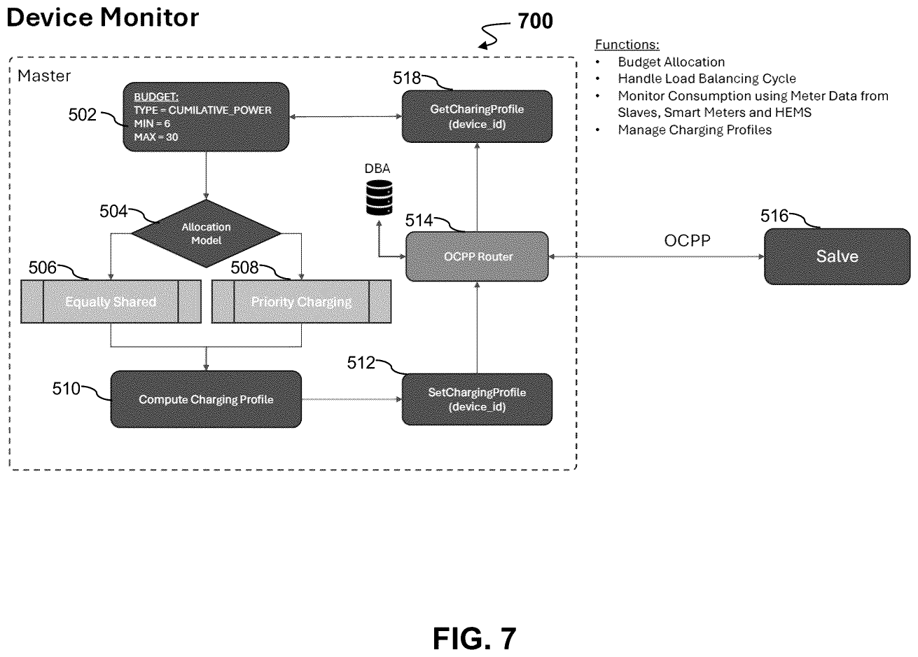

FIG. 7 depicts a flow chart for a budget allocation process using the present system and method, according to one embodiment. Referring to FIG. 7, the flowchart shows how the present system and method distributes energy. The device monitor module 700 in a master charging station may perform this budget allocation process for charging in each charging station. The budget allocation process may initiate by determining or learning power budget (step 502), and then an allocation model may be determined (step 504). In some embodiments, the allocation model may comprise at least two modes including an equal shared mode (step 506), which is just divided by the number of charging stations, and a priority charging mode (step 508), which allows users to pay a premium price for priority charging. Then, the device monitor module 700 may compute and set a charging profile for the charging session of the charging station based on the determined allocation model (steps 510, 512). The set charging profile may be transmitted to an OCPP router (step 514) and then also transmitted to the charging station (e.g., slave charging station) (step 516). The set charging profile for each charging session may be also stored in database administrator (DBA) and/or transmitted to another internal component to monitor and manage power (step 518).

As described above, the device monitor module 700 in a master charging station may be configured to allocate power budget to each charging station, handle load balancing cycle, monitor consumption using meter data from slave charging stations, smart meters, and/or Home Energy Management System (HEMS), and manage charging profiles.

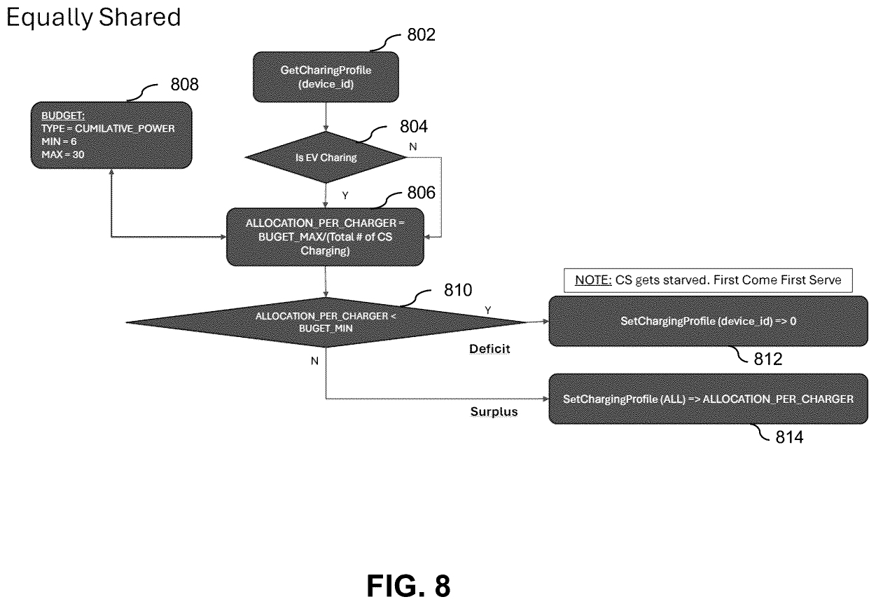

FIG. 8 depicts a flow chart for an equal shared mode 800 of a budget allocation process, according to one embodiment. Referring to FIG. 8, based on the set charging profile (step 802), whether the EV is charging in progress (step 804), and the power budget (step 808), in the equal shared mode, the master charging station may provide an allocation per charging station based on the budget divided by the total number of charging stations (step 806). Even if the master charging station provides an allocation to charging stations by dividing the budget by the total number, the EV may not have capability to consume that allocation. In other words, the EV may not be able to charge at the same energy level the charging station can provide. For example, some EVs may only be able to charge at approximately 16 amps while the charging station can provide approximately 30 amps. When the charging session is established between the EV and charging station, the charging station may inform the EV of the max energy it can provide, and the charging station may set the energy level based on its energy consumption capacity. The master charging station may be configured to detect this consuming limit of the EV and determine whether the budget allocation is the deficit or surplus of energy in the charging station (step 810). In the step 810, “ALLOCATION_PER_CHARGER” may refer to a budget allocation per charging station and “BUDGET_MIN” may refer to the minimum amperage the vehicle will charge at.

In the case of the deficit of energy, the charging station may get starved. In some embodiments, the allocation process for the charging stations in the cluster may be operated on a first come first serve basis. The master charging station may redistribute to other charging stations that need more energy (steps 812, 814). In some embodiments, the system may further include smart meters in the network. Using the meters, each charging station may provide meter values, which show how much energy is reallocated and how much energy the EV is consuming. This meter values may show surplus or deficit of energy in the charging station. If the EV consumes energy at a rate less than the charging station's allocated energy budget, the master charging station in the LLM system may detect this by sampling the meter values from the charging station and then modify the energy budget to provide more energy to the other charging stations in the cluster.

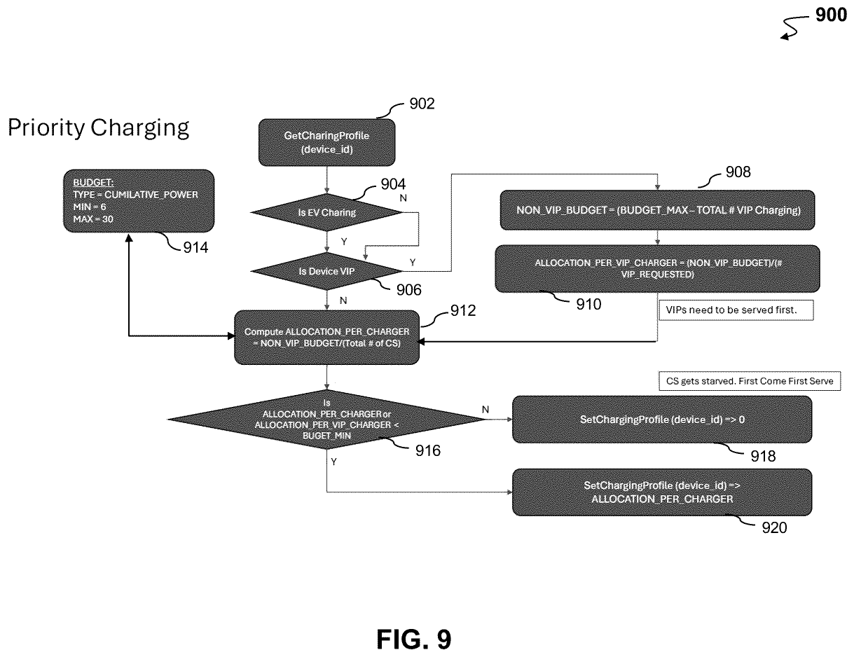

FIG. 9 depicts a flow chart for a priority charging mode 900 of a budget allocation process, according to one embodiment. Referring to FIG. 9, the priority charging mode of the budget allocation process may be performed based on the set charging profile (step 902), whether the EV is charging in progress (step 904), whether the EV is VIP that requests its charging session in a priority charging mode (step 906), and the power budget (step 914). If the EV is VIP, the system may calculate the budget for the charging stations connected to the non-VIP EVs, the budget for the charging stations connected to the VIP EVs, the allocation for the VIP EV, and the allocation for the non-VIP EVs based on the number of the charging stations of the VIP EVs and non-VIP EVs (steps 908, 910, 912). In the priority charging mode, the master charging station may ramp down the other charging stations and allocate more energy to the priority charging station. In this case, the charging stations connected to the VIP EVs in the priority charging mode may be served first in order to meet their energy requirements. Then, if there is energy capacity available, non-VIP EVs may be served on a first come equal share basis. The master charging station may be configured to detect the consuming limit of the EV and determine whether the budget allocation is the deficit or surplus of energy in the charging station (step 916). Then, the master charging station may redistribute to other charging stations that need more energy (steps 918, 920).

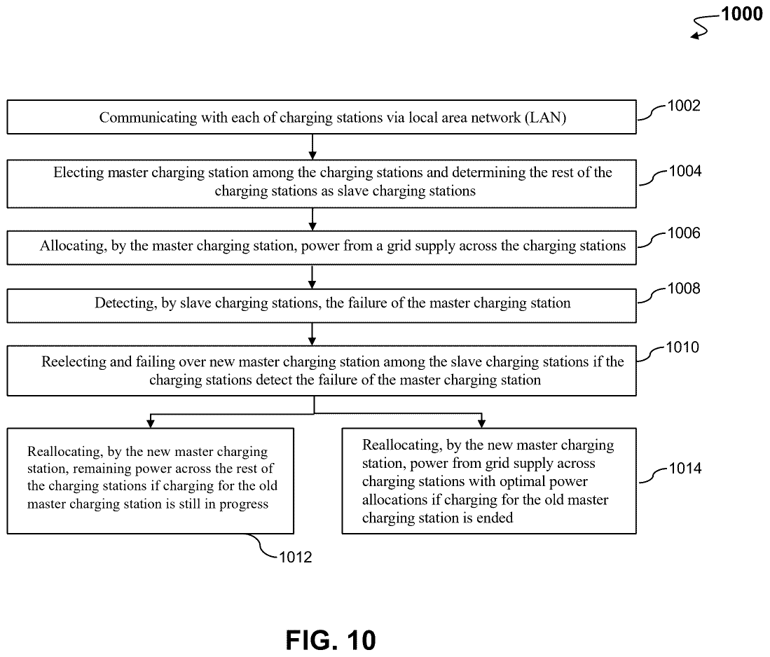

FIG. 10 depicts a flow chart for a method of local load management, according to one embodiment. Referring to FIG. 10, the method 1000 may include: communicating, by the backend, with each of charging stations via a local area network (LAN) (step 1002); electing, by the backend, a master charging station among the charging stations and determining the rest of the charging stations as slave charging stations (step 1004); allocating, by the master charging station, power from a grid supply across the charging stations on the LAN (step 1006); detecting, by slave charging stations, the failure of the master charging station (step 1008); reelecting and failing over, by the backend, to another charging station that is configured to be elected as a new master charging station among the slave charging stations if the charging stations detect the failure of the master charging station (step 1010); reallocating, by the new master charging station, remaining power across the rest of the charging stations on the LAN if charging for the old master charging station is still in progress (step 1012); and reallocating, by the new master charging station, the power across the charging stations with optimal power allocations if charging for the old master charging station is ended (step 1014).

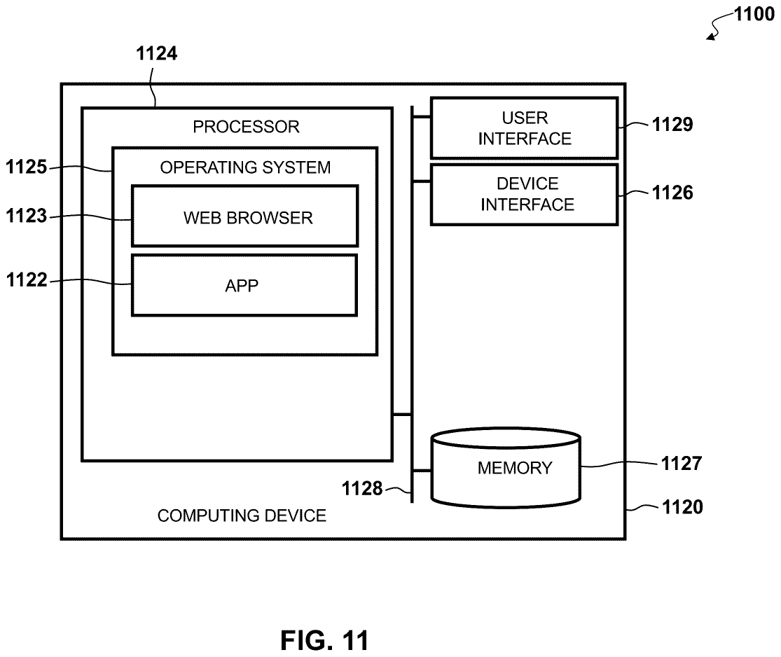

FIG. 11 illustrates an example of a top-level functional block diagram of a computing device embodiment 1100. The example operating environment is shown as a computing device 1120 comprising a processor 1124, such as a central processing unit (CPU), addressable memory 1127, an external device interface 1126, e.g., an optional universal serial bus port and related processing, and/or an Ethernet port and related processing, and an optional user interface 1129, e.g., an array of status lights and one or more toggle switches, and/or a display, and/or a keyboard and/or a pointer-mouse system and/or a touch screen. Optionally, the addressable memory may include any type of computer-readable media that can store data accessible by the computing device 1120, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a LAN, WAN, or the Internet. These elements may be in communication with one another via a data bus 1128. In some embodiments, via an operating system 1125, such as one supporting a web browser 1123 and applications 1122, the processor 1124 may be configured to execute steps of a process establishing a communication channel and processing according to the embodiments described above.

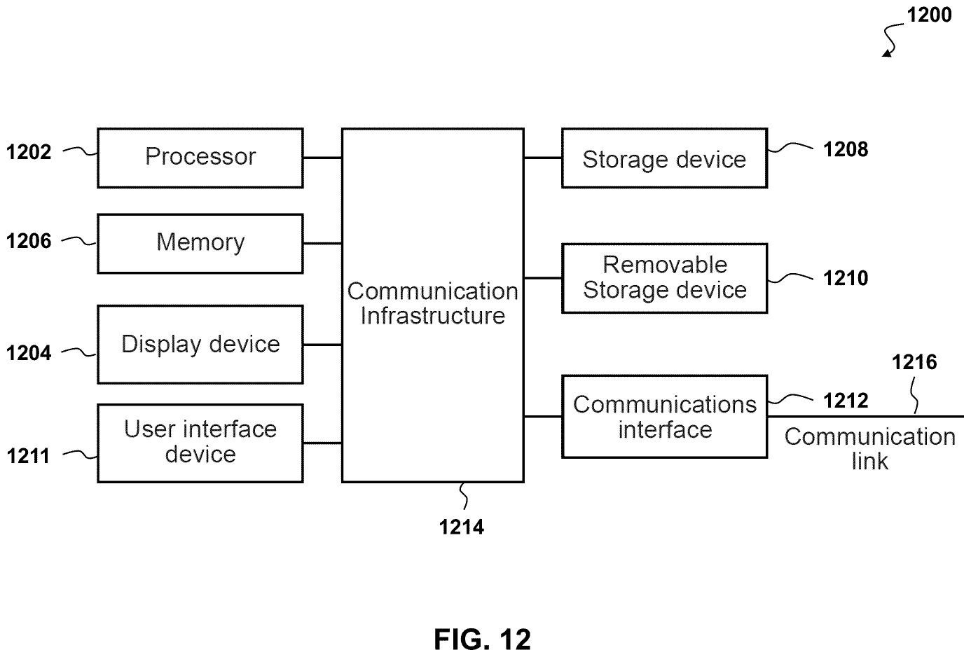

FIG. 12 is a high-level block diagram 1200 showing a computing system comprising a computer system useful for implementing an embodiment of the system and process, disclosed herein. Embodiments of the system may be implemented in different computing environments. The computer system includes one or more processors 1202, and can further include an electronic display device 1204 (e.g., for displaying graphics, text, and other data), a main memory 1206 (e.g., random access memory (RAM)), storage device 1208, a removable storage device 1210 (e.g., removable storage drive, a removable memory module, a magnetic tape drive, an optical disk drive, a computer readable medium having stored therein computer software and/or data), user interface device 1211 (e.g., keyboard, touch screen, keypad, pointing device), and a communication interface 1212 (e.g., modem, a network interface (such as an Ethernet card), a communications port, or a PCMCIA slot and card). The communication interface 1212 allows software and data to be transferred between the computer system and external devices. The system further includes a communications infrastructure 1214 (e.g., a communications bus, cross-over bar, or network) to which the aforementioned devices/modules are connected as shown.

Information transferred via communications interface 1214 may be in the form of signals such as electronic, electromagnetic, optical, or other signals capable of being received by communications interface 1214, via a communication link 1216 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1212. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

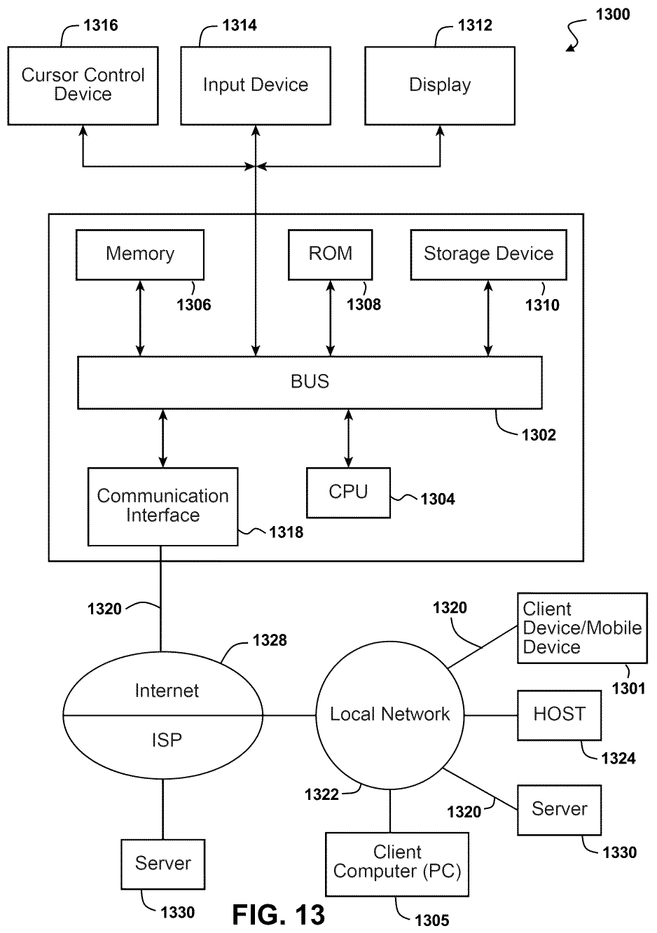

FIG. 13 shows a block diagram of an example system 1300 in which an embodiment may be implemented. The system 1300 includes one or more client devices 1301 such as consumer electronics devices, connected to one or more server computing systems 1330. A server 1330 includes a bus 1302 or other communication mechanism for communicating information, and a processor (CPU) 1304 coupled with the bus 1302 for processing information. The server 1330 also includes a main memory 1306, such as a random access memory (RAM) or other dynamic storage device, coupled to the bus 1302 for storing information and instructions to be executed by the processor 1304. The main memory 1306 also may be used for storing temporary variables or other intermediate information during execution or instructions to be executed by the processor 1304. The server computer system 1330 further includes a read only memory (ROM) 1308 or other static storage device coupled to the bus 1302 for storing static information and instructions for the processor 1304. A storage device 1310, such as a magnetic disk or optical disk, is provided and coupled to the bus 1302 for storing information and instructions. The bus 1302 may contain, for example, thirty-two address lines for addressing video memory or main memory 1306. The bus 1302 can also include, for example, a 32-bit data bus for transferring data between and among the components, such as the CPU 1304, the main memory 1306, video memory and the storage 1310. Alternatively, multiplex data/address lines may be used instead of separate data and address lines.

The server 1330 may be coupled via the bus 1302 to a display 1312 for displaying information to a computer user. An input device 1314, including alphanumeric and other keys, is coupled to the bus 1302 for communicating information and command selections to the processor 1304. Another type or user input device comprises cursor control 1316, such as a mouse, a trackball, or cursor direction keys for communicating direction information and command selections to the processor 1304 and for controlling cursor movement on the display 1312.

According to one embodiment, the functions are performed by the processor 1304 executing one or more sequences of one or more instructions contained in the main memory 1306. Such instructions may be read into the main memory 1306 from another computer-readable medium, such as the storage device 1310. Execution of the sequences of instructions contained in the main memory 1306 causes the processor 1304 to perform the process steps described herein. One or more processors in a multi-processing arrangement may also be employed to execute the sequences of instructions contained in the main memory 1306. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1304 for execution. Such a medium may take many forms, including but not limited to, non-volatile media, volatile media, and transmission media. Non-volatile media includes, for example, optical or magnetic disks, such as the storage device 1310. Volatile media includes dynamic memory, such as the main memory 1306. Transmission media includes coaxial cables, copper wire and fiber optics, including the wires that comprise the bus 1302. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1304 for execution. For example, the instructions may initially be carried on a magnetic disk of a remote computer. The remote computer can load the instructions into its dynamic memory and send the instructions over a telephone line using a modem. A modem local to the server 1330 can receive the data on the telephone line and use an infrared transmitter to convert the data to an infrared signal. An infrared detector coupled to the bus 1302 can receive the data carried in the infrared signal and place the data on the bus 1302. The bus 1302 carries the data to the main memory 1306, from which the processor 1304 retrieves and executes the instructions. The instructions received from the main memory 1306 may optionally be stored on the storage device 1310 either before or after execution by the processor 1304.

The server 1330 also includes a communication interface 1318 coupled to the bus 1302. The communication interface 1318 provides a two-way data communication coupling to a network link 1320 that is connected to the world wide packet data communication network now commonly referred to as the Internet 1328. The Internet 1328 uses electrical, electromagnetic or optical signals that carry digital data streams. The signals through the various networks and the signals on the network link 1320 and through the communication interface 1318, which carry the digital data to and from the server 1330, are exemplary forms or carrier waves transporting the information.

In another embodiment of the server 1330, interface 1318 is connected to a network 1322 via a communication link 1320. For example, the communication interface 1318 may be an integrated services digital network (ISDN) card or a modem to provide a data communication connection to a corresponding type of telephone line, which can comprise part of the network link 1320. As another example, the communication interface 1318 may be a local area network (LAN) card to provide a data communication connection to a compatible LAN. Wireless links may also be implemented. In any such implementation, the communication interface 1318 sends and receives electrical electromagnetic or optical signals that carry digital data streams representing various types of information.

The network link 1320 typically provides data communication through one or more networks to other data devices. For example, the network link 1320 may provide a connection through the local network 1322 to a host computer 1324 or to data equipment operated by an Internet Service Provider (ISP). The ISP in turn provides data communication services through the Internet 1328. The local network 1322 and the Internet 1328 both use electrical, electromagnetic or optical signals that carry digital data streams. The signals through the various networks and the signals on the network link 1320 and through the communication interface 1318, which carry the digital data to and from the server 1330, are exemplary forms or carrier waves transporting the information.

The server 1330 can send/receive messages and data, including e-mail, program code, through the network, the network link 1320 and the communication interface 1318. Further, the communication interface 1318 can comprise a USB/Tuner and the network link 1320 may be an antenna or cable for connecting the server 1330 to a cable provider, satellite provider or other terrestrial transmission system for receiving messages, data and program code from another source.

The example versions of the embodiments described herein may be implemented as logical operations in a distributed processing system such as the system 1300 including the servers 1330. The logical operations of the embodiments may be implemented as a sequence of steps executing in the server 1330, and as interconnected machine modules within the system 1300. The implementation is a matter of choice and can depend on performance of the system 1300 implementing the embodiments. As such, the logical operations constituting said example versions of the embodiments are referred to for e.g., as operations, steps or modules.

Similar to a server 1330 described above, a client device 1301 can include a processor, memory, storage device, display, input device and communication interface (e.g., e-mail interface) for connecting the client device to the Internet 1328, the ISP, or LAN 1322, for communication with the servers 1330.

The system 1300 can further include computers (e.g., personal computers, computing nodes) 1305 operating in the same manner as client devices 1301, wherein a user can utilize one or more computers 1305 to manage data in the server 1330.

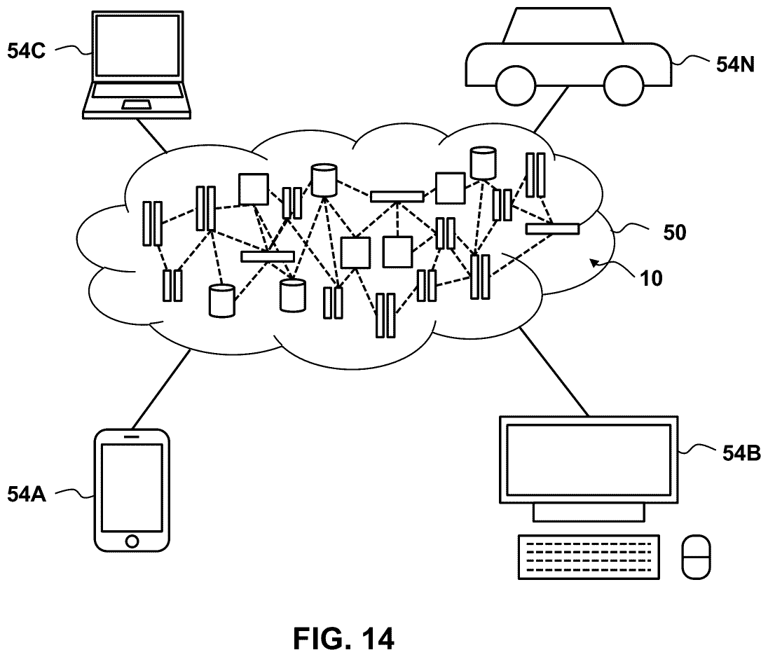

Referring now to FIG. 14, illustrative cloud computing environment 50 is depicted in which embodiments can be implemented. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 14 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

What is claimed is:

1. A method comprising:
communicating between each of charging stations (CS1 to CS9) via a local area network (LAN);
electing, by the charging stations, a master charging station among the charging stations, wherein the rest of the charging stations that excludes the master charging station include slave charging stations; and
allocating, by the master charging station, power from a grid supply across the charging stations on the LAN.

2. The method of claim 1, wherein the master charging station is configured to allocate the power in two modes including:
an equal shared mode where an allocation for each of the charging stations is configured to be determined equally by dividing the power by the number of the charging stations; and
a priority charging mode where an allocation for each of the charging stations is configured to be determined unevenly according to a price for priority charging.

3. The method of claim 1, further comprising:
detecting, by slave charging stations, the failure of the master charging station.

4. The method of claim 3, wherein the detecting the failure of the master charging station is performed by detecting loss of connectivity to the master charging station, and
wherein if the failure of the master charging station is detected, the slave charging stations begin an election process to elect a new master charging station.

5. The method of claim 4,
wherein while the master charging station in the failure state fails over to the new master charging station, active charging sessions via the charging stations are not disrupted.

6. The method of claim 5, wherein when the new master charging station is elected
and failed over, the master charging station in the failure state is configured to become an old master charging station;
wherein if charging for the old master charging station is still in progress, the old master charging station continues charging with a power allocation previously determined for an active charging session;
wherein the method further comprises:
reallocating, by the new master charging station, remaining power across the rest of the charging stations on the LAN; and
wherein the remaining power includes the power from the grid supply that excludes the power allocation to the old master charging station, and the rest of the charging stations includes the charging stations that excludes the old master charging station.

7. The method of claim 5, wherein when the new master charging station is elected and failed over, the master charging station in the failure state is configured to become an old master charging station;
wherein if charging for the old master charging station is ended, the method further comprises:
reallocating, by the new master charging station, the power across the charging stations with optimal power allocations for new charging sessions.

8. The method of claim 1, further comprising a cloud backend configured to be connected to the master charging station to manage charging of the charging stations,
wherein if the master charging station is disconnected from the cloud backend as an offline mode, the master charging station is configured to assume the role of the cloud backend until the connection is restored.

9. The method of claim 8, further comprises:
authenticating, by the charging stations, a vehicle to be charged based on database previously registered; and
wherein any new charging sessions for the charging stations in the offline state are allowed without a time limit.

10. The method of claim 1, wherein electing the master charging station among the charging stations is performed by comparing IP address of the charging stations.

11. A system comprising:
a cluster of charging stations (CS1 to CS9) configured to be supplied power from a grid supply (104) and communicate with each other via a local area network (LAN), wherein the charging stations include:
a master charging station configured to be elected among the charging stations, and slave charging stations including the rest of the charging stations; and
a backend (102) configured to be run on the master charging station and communicate with each of the charging stations via the LAN; and
wherein the master charging station is configured to allocate the power across the charging stations on the LAN.

12. The system of claim 11, wherein the master charging station is configured to allocate the power in two modes including:
an equal shared mode where an allocation for each of the charging stations is configured to be determined equally by dividing the power by the number of the charging stations; and
a priority charging mode where an allocation for each of the charging stations is configured to be determined unevenly according to a price for priority charging.

13. The system of claim 11, wherein the charging stations in the cluster are configured to detect the failure of the master charging station.

14. The system of claim 13, wherein detecting the failure of the master charging station is performed by detecting loss of connectivity to the master charging station, and wherein if the failure of the master charging station is detected, the slave charging stations begin an election process to elect a new master charging station.

15. The system of claim 14, wherein while the master charging station in the failure state fails over to the new master charging station, active charging sessions via the charging stations are not disrupted.

16. The system of claim 15, wherein when the new master charging station is elected, the master charging station in the failure state is configured to become an old master charging station;
wherein if charging for the old master charging station is still in progress, the old master charging station continues charging with an allocation previously determined for an active charging session;
wherein the new master charging station is configured to reallocate remaining power across the rest of the charging stations on the LAN; and
wherein the remaining power includes the power from the grid supply that excludes the allocation to the old master charging station, and the rest of the charging stations includes the charging stations that excludes the old master charging station.

17. The system of claim 15, wherein when the new master charging station is elected, the master charging station in the failure state is configured to become an old master charging station,
wherein if charging for the old master charging station is ended, the new master charging station is configured to reallocate the power across the charging stations on the LAN, and new charging sessions for the charging stations occur at optimal power allocations.

18. The system of claim 11, further comprising a cloud backend configured to be connected to the master charging station to manage charging of the charging stations,
wherein if the master charging station is disconnected from the cloud backend as an offline mode, the backend run on the master charging station is configured to assume the role of the cloud backend until the connection is restored.

19. The system of claim 18,
wherein the charging stations are configured to authenticate a vehicle to be charged based on database previously registered; and
wherein any new charging sessions for the charging stations in the offline state are allowed without a time limit.

20. A method comprising:
electing, by charging stations, a master charging station among the charging stations, wherein the rest of the charging stations that excludes the master charging station include slave charging stations;
allocating, by the master charging station, power from a grid supply across the charging stations;
detecting, by the slave charging stations, the failure of the master charging station; and
reelecting, by the slave charging stations, a new master charging station among the slave charging stations if the failure of the master charging station is detected.
